(19) United States
(12) Patent Application Publication
(10) Pub. No.: US 2011/0278221 A1
(43) Pub. Date: Nov. 17, 2011

(54) INSTALLATION FOR THE TREATMENT OF UREA-CONTAINING WATER, TOILET, STABLE, AND METHOD

(75) Inventors: Christel Dominique Paule Paille, Leiden (NL); Christopher Andre Antoine Lasseur, Wassenaar (NL); Josef Johannes De Swart, Soest (NL); C.J. de Swart, Soest (NL); Robertus Christiaan Josephus Suters, Rosmalen (NL)

(73) Assignee: EUROPEAN SPACE AGENCY, Paris (FR)

(21) Appl. No.: 13/062,505

(22) PCT Filed: Sep. 10, 2009
(86) PCT No.: PCT/NL09/50544

§ 371 Date: May 23, 2011

(30) Foreign Application Priority Data
Sep. 10, 2008 (NL) 2001974

(51) Int. Cl. C02F 3/22; E03D 5/016; C02F 3/02; C02F 3/12; C02F 101/16; C02F 103/20

(52) U.S. Cl. 210/620; 210/205; 210/196; 210/202; 210/153

(57) ABSTRACT

The invention relates to a device for treating urea-containing water. The invention also relates to a domestic toilet provided with such a device. The invention also relates to an animal accommodation provided with such a device. In addition, the invention comprises a method for treating urea-containing water. The device comprises a nitrification unit adapted to oxidize urea to nitrates and carbon dioxide, wherein the nitrification unit is also provided with an oxygen feed, a gas discharge and a throughfeed for feed of waste water nitrified by the nitrification unit to a filtration unit connected to the nitrification unit. The nitrification unit preferably comprises nitrifying bacteria.

The invention relates to a device for treating urea-containing water. The invention also relates to a domestic toilet provided with such a device. The invention also relates to an animal accommodation provided with such a device. In addition, the invention comprises a method for treating urea-containing water.

In densely populated areas as well as on farms the purification of domestic waste water or animal excreta is an exceptionally costly and time-consuming process. A component of waste water that is difficult to remove is urea (NH₂CONH₂) which enters the waste water, in the form of urea or salts of urea, via human and/or animal urine and excreta. Because of environmental problems such as acid rain, it is desirable to greatly reduce the urea content. In addition, urea generates a strong, undesirable odour in the form of ammonia (NH₃). Another problem is that urea enhances the undesirable growth of algae.

The invention has for its object to enable a reduction of the urea content in waste water.

The invention provides for this purpose a device for treating urea-containing water, comprising an inlet for urea-containing water which is connected to a nitrification unit adapted to oxidize urea to nitrate and carbon dioxide, wherein the nitrification unit is also provided with an oxygen feed, a gas discharge and a throughfeed for feed of waste water nitrified by the nitrification unit to a filtration unit connected to the nitrification unit, and wherein the filtration unit is provided with at least an outfeed for water purified by the nitrification unit and the filtration unit. Using such a device it is possible in simple manner to reduce, or even wholly remove, the urea content in water. For transport of the liquid between different components transport means can be arranged in the device, such as one or more pumps to be connected to for instance the infeed, throughfeed and/or outfeed. The oxidizing of urea to carbonate and nitrate is known as nitrification, and has the following general reaction:

NH₂CONH₂+4O₂>>HCO₃_{^{−}}+2NO₃_{^{−}}+3H⁺

This reaction is preferably performed by nitrifying micro-organisms, but can optionally also take place via chemical methods. The same reaction can take place making use of water-soluble salts of urea. Oxygen is supplied via the oxygen feed, preferably in gas form, for instance by means of air injected into the waste water using a pump. The oxygen thus injected into the nitrification unit is preferably controlled by measuring and control equipment such that the average dissolved quantity of oxygen in the liquid is held between 5 and 10 mg/L. Carbonate can escape via the gas discharge in the form of carbon dioxide (CO₂).

The reaction can be subdivided into the following reaction steps: in the presence of water urea (NH₂CONH₂) is converted into ammonium carbonate (NH₄)₂CO₃.

NH₂CONH₂+2H₂O>>(NH₄)₂CO₃ (1)

Carbonate is in equilibrium with its conjugated acid.

CO₃²^{_{−}}+H₂O>>HCO₃_{^{−}}+OH⁻ (2)

In the presence of oxygen ammonia can oxidize to nitrite.

2NH₄++3O₂>>2NO₂_{^{−}}+2H₂O+4H⁺ (3)

Nitrite is subsequently oxidized to nitrate.

2NO₂_{^{−}}+O₂>>2NO₃_{^{−}} (4)

An additional advantage is that, under the oxidizing conditions in the nitrification unit, other organic substances are also oxidized to carbonates/carbon dioxide. The water from the outfeed is found to be usable for high-grade applications after nitrification and filtration. Depending on the types of filter used, even human consumption is possible with some further processing to optimize the taste. The filtered residue can be removed periodically or continuously from the filter. The filters can be cleaned or replaced after a period of time in order to prevent fouling or blockage.

In a preferred embodiment the nitrification unit comprises nitrifying bacteria. Nitrifying bacteria are able to perform the above reaction steps in particularly efficient manner, whereby it is possible to give the device a relatively compact form. The nitrifying unit comprises a bioreactor for this purpose. In addition to nitrifying bacteria, the nitrification unit can also comprise other micro-organisms and optionally chemical, electrical and/or mechanical aids. Suitable nitrifying bacteria as referred to in this description are commercially available via, among others, LGC Promochem Standards, Queens Road, Teddington, Middlesex TW11, 0LY, UK.

It is advantageous for the nitrifying bacteria to comprise nitrite-producing bacteria and nitrate-producing bacteria, wherein the nitrite-producing bacteria oxidize ammonia to nitrite and the nitrate-producing bacteria oxidize nitrite to nitrate. Oxygen must be added to the bacteria for the oxidizing reactions (3) and (4) above.

In a preferred embodiment the nitrite-producing bacteria comprise at least one genus chosen from the group consisting of Nitrosomonas, Nitrosospira and Nitrosococcus. These genera can be used particularly well in a bioreactor, and are commercially available. An advantage is that these nitrite-producing bacteria have a large capacity such that the device can be given an exceptionally compact form. These bacteria degrade urea to ammonia and carbon dioxide as described above by means of the enzyme urease. A mixture of bacteria is preferably used.

In a preferred embodiment the nitrate-producing bacteria comprise at least one genus chosen from the group consisting of Nitrobacter, Nitrospira and Nitrococcus. These genera can be used particularly well in a bioreactor owing to a great stability and tolerance. They also have a relatively large converting capacity, whereby the device can be given a relatively compact form. The stated nitrate-producing bacteria are commercially available.

The bioreactor preferably comprises a combination of the above stated nitrite-producing bacteria and nitrate-producing bacteria. The bacteria can be cultured as synergistic population on a suitable growth medium in a reactor. The use of such a mixture of bacteria moreover has the advantage that the reactor has an increased purifying action and is able to remove a wide range of undesirable organic contaminants from the water, including diverse types of proteins and hormones.

It is advantageous for at least some of the nitrifying bacteria to be attached to a fixed carrier. It is thus simple to fix the bacteria in the installation, and also makes it simpler to replace the bacteria. The fixed carrier can form part of a fixed bed bioreactor. The fixed carrier can for instance comprise ceramic, glass or plastic beads, or a grid.

In a preferred embodiment the filtration unit comprises at least one osmosis filter. An osmosis filter removes a large part of the salts from the nitrified water. There is very little danger of osmosis filters becoming blocked. Another advantage is that the separated salts can be discharged as concentrated solution, this being simpler than the removal of solids.

The outfeed of the filtration unit is preferably also provided with a feedback for feeding back at least a part of the purified water to the nitrification unit and/or the filtration unit. The ratio of purified water and urea-containing water fed to the nitrification unit can be regulated by means of regulating means such that the nitrification proceeds optimally. The fed back purified water reduces the chance of blockages of the filtration unit.

It is advantageous if the throughfeed is also provided with a second feed for supplying water not containing urea. This makes it simpler and more efficient to keep control of the amount of water and the concentration of urea and other components using measuring and control equipment known in the prior art and suitable for this purpose. In addition, the feed of water not containing urea after the nitrification unit enables a better utilization of the filtration unit.

In addition to a feedback of the purified water, it is also possible to envisage supplying additional water, for instance waste water from other household sources such as showers and wash basins, also referred to as so-called greywater. The second feed is preferably provided with a filter suitable for removing at least soap residues from the water not containing urea, in particular a nanofilter. Such a filter, preferably an ultrafilter, makes it possible to remove soap residues which could possibly clog other filters in the device. Use of such a prefiltration is found to give a better operation of the device, and the chance of clogging of other filters of the device is reduced. The device is also found to use less energy per processed unit of urine-containing waste water. The removal of soap residues also has a positive effect on the functioning of the nitrification unit.

The filtration unit is preferably provided with at least one filtration membrane. A membrane enables a good filtration. The degree of fouling or clogging of the membrane can be determined from the flow resistance through the membrane. The filtration unit is preferably provided with discharge means for discharging the insoluble fraction of the waste water separated by the filtration membrane. Suitable types of filter are commercially available and comprise, among others, ultrafiltration membranes, nanofiltration membranes and reverse osmosis membranes. Ultrafiltration membranes have a pore size between 0.02 and 0.2 micron, and can operate under a transmembrane pressure of 1-10 bar. Nanofiltration membranes have a pore size of less than 0.002 micron and operate under pressures of 5-35 bar. The filtration membranes can be given a spiral or tubular form, wherein tubular models are preferred since they are fouled less quickly. The filters are manufactured from plastic materials (for instance PDVF, polyamides, polyvinyl and/or polysulphone) or ceramic material, wherein ceramic is recommended due to a greater robustness. A layer of residue can form on the filter after a period of time, thereby reducing the filtration efficiency. Reverse osmosis membranes have a pore size of less than 0.002 micron and operate at a pressure of 8-50 bar. These reverse osmosis membranes remove 95-99% of the solid residue from the liquid and 99% of the bacteria. The reverse osmosis membranes are generally manufactured from plastic. The purified water can be readily reused as a result.

The filtration unit is more preferably provided with at least two filtration membranes placed in series. The connection in series enables an improved purification. More than two filtration membranes in series enable an even better purification, but further increase the flow resistance. The flow resistance at the same flow rate can be reduced by parallel connection of a plurality of filtration units.

It is particularly advantageous for the filtration unit to comprise at least one reverse osmosis membrane, wherein the osmosis membrane is preceded in the intended flow direction by at least one filter adapted to remove osmotically active substances, in particular bivalent salts. The filter preceding the reverse osmosis membrane ensures that the reverse osmosis proceeds more efficiently. Filters suitable for removing bivalent salts are for instance nanofilters. It is most advantageous when at least two successive reverse osmosis filters are placed in series after the nanofilter. The removal of at least a part of the bivalent salts is found to significantly improve the functioning of the nitrification process. The filtered-out salts can be discharged and are compatible with regular sewage treatment plants.

It is advantageous for the inlet of the nitrification unit to be provided with separating means for separating solids from the urea-containing water. These separating means, for instance a settling tank or suitable filters, prevent the operation of the nitrification unit being impeded by solids.

The invention further relates to a domestic toilet provided with a device according to the invention. It thus becomes possible to locally clean the waste water from a domestic toilet in efficient manner. The purified water can be immediately reused locally, so that a significant water-saving can be realized. This is particularly important in places where water is scarce. The device according to the invention is preferably integrated into the toilet. The toilet is preferably also provided with separating means for the purpose of separating the urine-containing liquid phase, which is the most suitable for treatment with the device according to the invention, from the solid phase which is less suitable and can cause problems in fixed bed reactors and filters. The solid phase can then be discharged separately. For use in a toilet for liquid excreta, in particular a urinal, such separating means are generally not necessary.

The invention also relates to an animal accommodation, in particular a livestock accommodation, provided with a device according to the invention. Not only is water thus saved, it is also prevented in simple manner that environmental restrictions relating to the discharge of waste products from manure are not exceeded. This is particularly important in intensive livestock farming of for instance cattle, pigs and/or poultry. A plurality of animal accommodations can make use of a single device according to the invention, wherein the manure discharge from an animal accommodation is connected to the inlet of the device. The animal accommodation is preferably provided with separating means adapted to feed the urine-containing liquid phase to the device according to the invention separated from the solid component of the collected excreta.

The invention also provides a method for purifying urea-containing water, comprising the processing steps of: nitrifying urea, and filtering the nitrified water, wherein the processing steps are performed in a device according to the invention. Such a method provides the advantages as described above.

The invention will now be elucidated on the basis of the following examples.

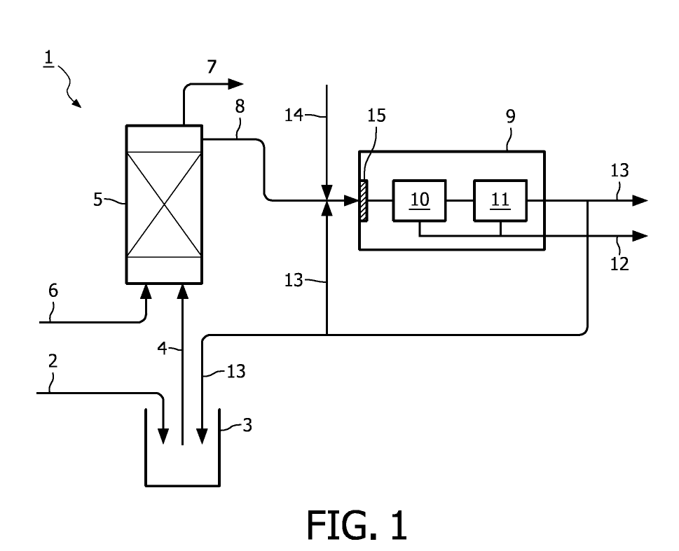

FIG. 1 shows schematically a device according to the invention.

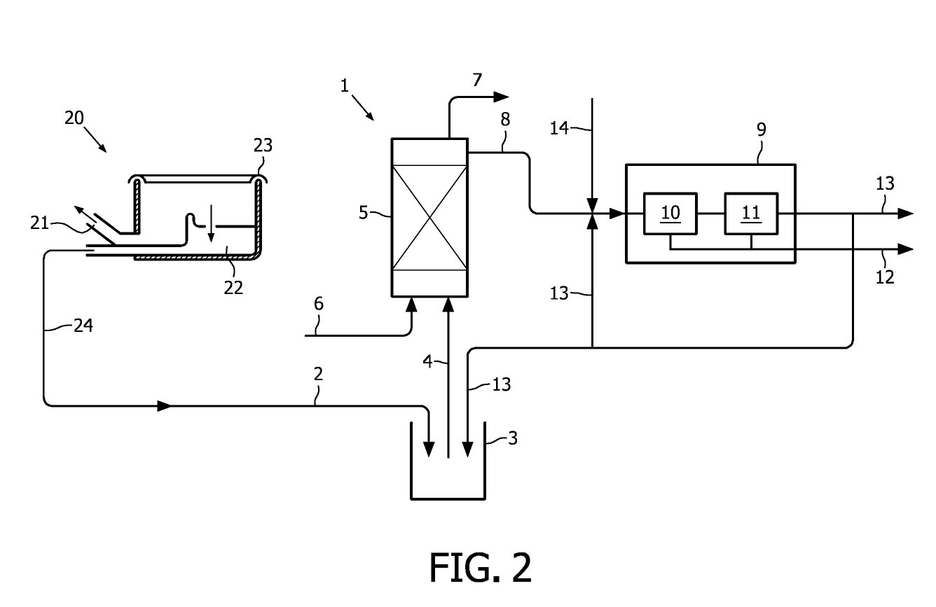

FIG. 2 shows an assembly of a device according to the invention with a toilet.

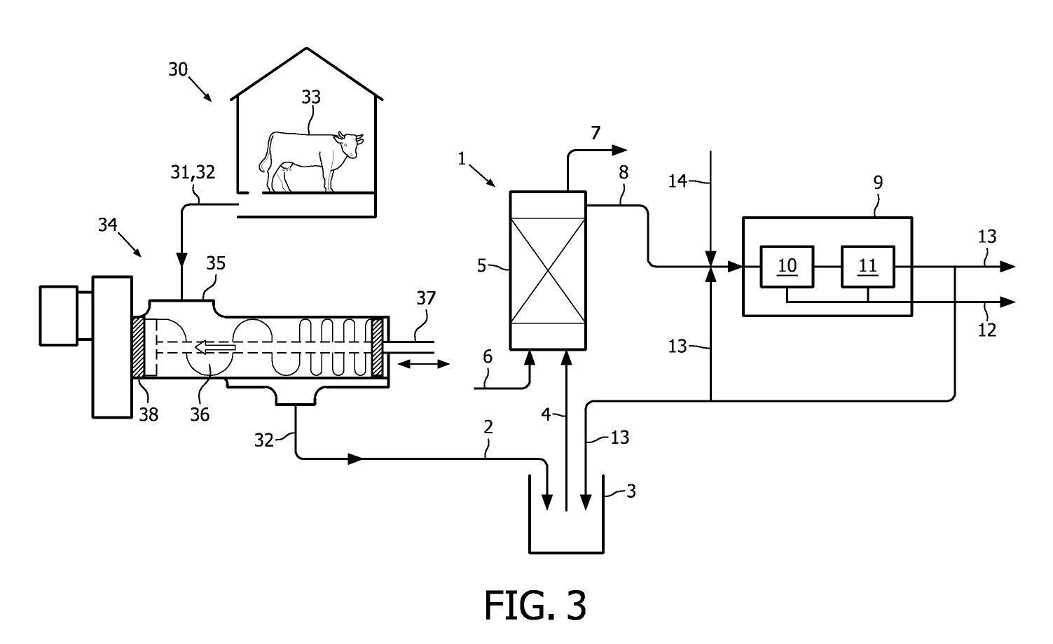

FIG. 3 shows an assembly of a device according to the invention with an animal accommodation.

Device 1 according to the invention has an inlet 2 for urea-containing water. The urea is separated beforehand from a possible solid component of the excreta for processing, for instance by means of a settling tank (not shown) and/or a microfilter. The urea-containing water is admitted into the device via a mixing vessel 3, wherein the concentration is optimized for further processing, optionally by admixing water. The thus pretreated water 4 is carried to nitrification unit 5. Oxygen 6 is also fed to nitrification unit 5. The nitrification unit is a fixed bed bioreactor in which nitrifying bacteria are placed, for instance the nitrite-producing bacteria Nitrosomonas, Nitrosospira, and/or Nitrosococcus, in combination with nitrate-producing bacteria such as Nitrobacter, Nitrospira and/or Nitrococcus. In this example a combination of Nitrospira and Nitrosomas is applied. For use with a single toilet a nitrification unit 5 with a volume of about 70 litres is generally sufficient. Provided it is filled with sufficient micro-organisms, such a unit 5 can process about 20 litres of urine a day. These nitrifying bacteria convert urea oxidatively via nitrite into nitrate and carbon dioxide, which is removed from bioreactor 5 by means of a gas discharge 7. The bioreactor is provided with measuring and control equipment with which the infeed of oxygen and waste water 4 is regulated. The volume of bioreactor 5 is chosen such that at the throughfeed flow rate the content of urea is reduced to less than 5% of the original content, whereby the typical odour of urea practically disappears.

The nitrified water 8 is carried to a filtration unit 9 comprising two osmosis filters 10, 11 placed in series. In addition to nitrates (NO₃—), other salts in the waste flow are also separated for the greater part by first osmosis filter 10 and second osmosis filter 11, in particular ions such as Na⁺, Cl⁻, SO₄²⁻, PO₄³⁻, K⁺ and Ca²⁺. These separated concentrated salt solutions 12 are discharged. About 98% of the phosphates are removed from the waste flow. Waste water 14 not containing urea (for instance from a shower or wash basin) can optionally be admixed to the nitrified water 8 fed to filtration unit 9. Such water 14, referred to as greywater, generally does not require nitrification: filtration is sufficient to make greywater suitable for reuse. The unit in this example can treat about 80 litres of greywater a day, wherein the device is relatively compact. The greywater feed is optionally provided with an ultrafilter or nanofilter, which can be built into the device but which can also be arranged externally. In this example however, a nanofilter 15 is already integrated into filtration unit 9. Such filter is suitable for the removal of, among other substances, soap residues, whereby the other filters 10, 11 in filter unit 9 run less risk of blockages. Filtering of the admixed greywater also contributes toward a lower energy consumption.

Membranes 10, 11 in the filtration unit can become fouled after a period of time and timely cleaning or replacement is necessary. A plurality of membranes 10, 11 can optionally be placed in parallel so that the filtration unit can remain operational while one of the membranes is deactivated for maintenance. In this example three filtration steps are used: one nanofiltration filter 15 and two reverse osmosis filters 10, 11. Nanofiltration filter 15 removes a large part of the bivalent salts, including calcium salts and sulphates, thereby reducing the osmotic pressure in the subsequent reverse osmosis frustrations, and the reverse osmosis proceeds in more energy-efficient manner in the following filters 10, 11. For use in a single toilet with a urine production of 20 litres or less, it is sufficient that the nanofiltration filter has a surface area of 0.24 m², the first reverse osmosis filter has a surface area of 2.6 m² and the second reverse osmosis filter a surface area of 1.3 m².

After treatment by unit 1 purified water can be obtained with the following properties as shown in Table I.

TABLE I
Example of properties of urine-containing water purified
according to the invention.

| | |
|---|---|
| pH | 7.0-7.50 |
| Conductivity (mS/cm) | 25-35 |
| Organic carbon (ppm) | 5-10 |
| Fluoride (ppm) | 5 |
| Chloride (ppm) | 1480 |
| Nitrate (ppm) | 5310 |
| Phosphate (ppm) | 1160 |
| Sodium (ppm) | 860 |
| Potassium (ppm) | 450 |
| Ammonia (ppm) | 0.5 |

The shown values are averages, and for pH the variation in the measured values is shown. The water produced is suitable for consumption. These values were measured with the commercially available Dr. Lange kits, wherein ISO-certified measuring methods are used for pH measurement, electrical conductivity, quantity of organic carbon (TOC=total organic carbon) and the concentrations of diverse ions.

The water 13 purified by nitrification and filtration can subsequently be reused, for instance as washing water in the production of drinking water, wherein minerals generally still have to be added to obtained the desired taste. A part of the purified water 13 is optionally fed back to flotation tank 3. The concentration of urea in the pre-purified water 4 can thus be controlled by regulating means such that it lies in the optimum range for the nitrification in bioreactor 5. A part of the purified water 13 can also be fed back to filtration unit 9.

Device 1 according to the invention can, depending on the requirement, be embodied on different scales, for instance for the treatment of the average daily urea emission of a family, or of a livestock accommodation. The transport of liquids within device 1 is provided by conventional means, preferably automated electric pumps. Depending on the scale and on the degree of automation, and the source of the waste flow, the average amount of power required to clean a cubic metre of urea-containing water (in particular urine) varies. For instance for urine-containing water coming from people, the energy required amounts on average to 10 kWh/m³ waste for cleaning. For waste flows coming from pigs the energy consumption is considerably higher: an average of 30 kWh/m³. By way of comparison: for pigs an average energy consumption of 35 kWh/m³ has been measured for a similar waste flow using conventional techniques (chemical/mechanical), this showing clearly that the purification according to the invention operates in more energy-efficient manner.

FIG. 2 shows an assembly of a device 1 according to the invention, as described for FIG. 1, with a toilet 20. This toilet 20 is provided with separating means 21, 22 for separating liquid and solid parts. Diverse suitable separating means are commercially available for this purpose. In this example the separation takes place on the basis of the positioning and dimensioning, adapted to the sitting position 23 of a person on the toilet pot, of a first discharge 21 for substantially solid parts (substantially faeces) and a second discharge 22 for urine. The urine-containing liquid 24 is guided via the relevant discharge to device 1 according to the invention. It is possible to envisage integrating the device 1 according to the invention with a toilet, whereby a particularly compact assembly is possible.

FIG. 3 shows an assembly of a device 1 according to the invention integrated with an animal accommodation 30. A mixture of manure 31 and urine 32 from an animal 33, for instance a cow, are collected in animal accommodation 30 and carried to a separating device 34. Diverse types of separating device are commercially available. In this example separating device 34 comprises an inlet 35 in which the mixture of manure 31 and urine 32 is carried into a pressing space 36. Urine-containing liquid 32 is then pressed out of the solid substance (substantially manure) using a plunger 37. The solid substance is discharged as a relatively dry cake 38, and the urine-containing liquid phase 32 is discharged by means of an outlet to the device according to the invention. Shown in this example is a cowshed; a similar construction can however be envisaged for other animals such as pigs, chickens, turkeys. The purified water can for instance be reused as drinking water for the animals in animal accommodation 30.

1. Device for treating urea-containing water, comprising an inlet for urea-containing water which is connected to a nitrification unit adapted to oxidize urea to nitrates and carbon dioxide, wherein the nitrification unit is also provided with an oxygen feed, a gas discharge and a throughfeed for feed of waste water nitrified by the nitrification unit to a filtration unit connected to the nitrification unit, and wherein the filtration unit is provided with at least an outfeed for water purified by the nitrification unit and the filtration unit.

2. Device as claimed in claim 1, characterized in that
the nitrification unit comprises nitrifying bacteria.

3. Device as claimed in claim 2, characterized in that
the nitrifying bacteria comprise nitrite-producing bacteria and nitrate-producing bacteria, wherein the nitrite-producing bacteria oxidize ammonia to nitrite and the nitrate-producing bacteria oxidize nitrite to nitrate.

4. Device as claimed in claim 3, characterized in that
the nitrite-producing bacteria comprise at least one genus chosen from the group consisting of Nitrosomonas, Nitrosospira and Nitrosococcus.

5. Device as claimed in claim 3, characterized in that
the nitrate-producing bacteria comprise at least one genus chosen from the group consisting of Nitrobacter, Nitrospira and Nitrococcus.

6. Device as claimed in claim 2, characterized in that
at least some of the nitrifying bacteria are attached to a fixed carrier.

7. Device as claimed in claim 1, characterized in that
the outfeed of the filtration unit is also provided with a feedback for feeding back at least a part of the purified water to at least one of the nitrification unit and the filtration unit.

8. Device as claimed in claim 1, characterized in that
the throughfeed is also provided with a second feed for supplying water not containing urea.

9. Device as claimed in claim 8, characterized in that the second feed is provided with a filter suitable for removing at least soap residues from the water not containing urea.

10. Device as claimed in claim 1, characterized in that
the filtration unit is provided with at least one filtration membrane.

11. Device as claimed in claim 10, characterized in that the filtration unit comprises at least one reverse osmosis membrane, wherein the osmosis membrane is preceded in the intended flow direction by at least one nanofilter adapted to remove osmotically active substances.

12. Device as claimed in claim 1, characterized in that
the inlet of the nitrification unit is provided with separating means for separating solid residue from the urea-containing water.

13. Domestic toilet provided with a device as claimed in claim 1, wherein the toilet outlet is connected to the inlet of the nitrification unit.

14. Animal accommodation provided with a device as claimed in claim 1.

15. Method for purifying urea-containing water, comprising the processing steps of:
nitrifying urea; and
filtering the nitrified water,
wherein the processing steps are performed in a device as claimed in claim 1.

16. Animal accommodation as claimed in claim 14, characterized in that the animal accommodation is a livestock accommodation.

17. Device as claimed in claim 9, characterized in that the filter is a nanofilter.

18. Device as claimed in claim 11, characterized in that the at least one nanofilter is adapted to remove bivalent salts.
